(19) United States
(12) Patent Application Publication
(10) Pub. No.: US 2024/0122680 A1
(43) Pub. Date: Apr. 18, 2024

(54) TRANSMUCOSAL BASE WITH IMPROVED LONGITUDINAL THROUGH-PASSAGE

(71) Applicant: ANTHOGYR, Sallanches (FR)

(72) Inventor: Hervé Richard, Notre Dame de Bellecombe (FR)

(21) Appl. No.: 18/278,243

(22) PCT Filed: Mar. 11, 2022
(86) PCT No.: PCT/IB2022/052196

§ 371 Date: Aug. 22, 2023

(30) Foreign Application Priority Data
Mar. 16, 2021 (EP) 21162975.3

(51) Int. Cl. A61C 8/00

(52) U.S. Cl. CPC A61C 8/0054; A61C 8/0068

(57) ABSTRACT

A transmucosal base for receiving a dental prosthesis on a dental implant extends in a longitudinal direction (I-I) between a proximal end and a distal end. The transmucosal base includes a proximal portion shaped so as to be received in or on a dental implant, a distal portion shaped so as to support a dental prosthesis, a longitudinal through-passage successively including an upstream cylindrical portion, a seat for a screw, and a downstream cylindrical portion bounded by a side wall. The transmucosal base includes, in the longitudinal through-passage, a radial inner housing arranged in the peripheral wall of the seat and in the side wall of the downstream cylindrical portion.

### TECHNICAL FIELD OF THE INVENTION

The present invention relates to the field of dental restoration and relates more particularly to a transmucosal base for receiving a dental prosthesis on a dental implant.

In general, as described in document US 2020/046468 A1, such a transmucosal base extends in a longitudinal direction between a proximal end and a distal end, and comprises:
a proximal portion shaped to be received in or on a dental implant,
a distal portion shaped to support a dental prosthesis,
a longitudinal through-passage successively comprising an upstream cylindrical portion extending in the direction of the proximal end as far as a seating bounded by a seating peripheral wall and having a bearing surface intended to have the head of a screw bearing axially against it, and a downstream cylindrical portion bounded by a lateral wall and extending from and away from the seating in the direction of the distal end.

It is customary for the dental prosthesis to be mounted and fixed on such a transmucosal base, for example using adhesive bonding, so as to form an assembly which is then mounted and fixed on or in an implant by means of a fixing screw.

In order to carry out maintenance on the dental prosthesis, it is preferable to have the ability to separate the assembly from the dental implant without having to separate the dental prosthesis from the transmucosal base. Specifically, the forces applied to separate the dental prosthesis from the transmucosal base of an assembly still fixed to an implant would lead to undesirable stresses on the implant which could damage its osteointegration.

Easy separation of the assembly from the dental implant can be obtained by means of a dental prosthesis having a through-passage for the passage of the fixing screw both for inserting and for removing it. Recourse is then had to a dental prosthesis that comprises a through-passage substantially formed by first and second successive passage portions, said first passage portion extending from a proximal end of the dental prosthesis substantially along a first longitudinal axis and said second passage portion extending the first passage portion substantially along a second longitudinal axis such that the first and second passage portions make between them a non-zero angle. The proximal end of the dental prosthesis is intended to come to bear against the distal portion of the transmucosal base.

For a restoration that is satisfactory from an esthetic standpoint, dependent notably on the height of the soft tissues (mucosa) of the patient, the transmucosal base needs to extend over greater or lesser lengths in the longitudinal direction.

The problem is that the longer the transmucosal base, the longer the screw for fixing it to the dental implant needs to be. And the longer the screw, the more the angle between the first and second passage portions has to tend toward zero, or the greater the transverse dimensions of the orifice in the second passage portion need to be. This then quickly results in an excessively large diameter for the orifice of the second passage portion, and in the orifice in the second passage portion being positioned such that it is in conflict with the anatomical obstacles represented by the cusps or the free edge of the dental prosthesis, making the restoration esthetically unattractive (transparency) or weak as a result of having excessively thin walls.

### SUMMARY OF THE INVENTION

One problem addressed by the present invention is that of providing a transmucosal base that facilitates the passage of a fixing screw through a dental prosthesis.

At the same time, the invention seeks to provide a transmucosal base that makes it possible to reduce the dimension of the orifice of the second passage portion and makes it possible to increase the possibilities of situating the orifice of the second passage portion away from the anatomical obstacles (cusps or free edge) of the dental prosthesis.

In order to achieve these objectives, as well as others, the invention proposes a transmucosal base for receiving a dental prosthesis on a dental implant, extending in a longitudinal direction between a proximal end and a distal end, comprising:
a proximal portion shaped to be received in or on a dental implant,
a distal portion shaped to support a dental prosthesis,
a longitudinal through-passage successively comprising an upstream cylindrical portion extending in the direction of the proximal end as far as a seating bounded by a seating peripheral wall and having a bearing surface intended to have the head of a screw bearing axially against it, and a downstream cylindrical portion bounded by a lateral wall and extending from and away from the seating in the direction of the proximal end;
   according to the invention the transmucosal base comprises, in the longitudinal through-passage, an internal radial housing formed in the peripheral wall of the seating and in the lateral wall of the downstream cylindrical portion.

The internal radial housing makes it possible to receive, in the longitudinal through-passage, the free end of the threaded shank of the screw oriented obliquely, beyond the seating (all the way into at least part of the downstream cylindrical portion). The passage of the screw through the dental prosthesis thereby becomes easier, with a second passage portion the orifice of which can be placed further away from the cusps or from the free edge of the dental prosthesis.

The creation of the internal radial housing removes only some of the peripheral wall of the seating, which seating remains entirely capable of having the screwhead bear axially against it for satisfactory retention of the transmucosal base on the dental implant. As a preference, the seating may comprise a bearing surface that is at least 50% of the surface that the seating would have had in the absence of the internal radial housing.

Advantageously, provision can be made such that:
the proximal portion is progressively flared in the direction of the distal portion,
the seating is frustoconical, flaring in the direction of the upstream cylindrical portion, the internal radial housing being formed in part in the peripheral wall of the seating.

The progressive flaring of the proximal portion substantially reproduces the shape of the root of a tooth to come into contact with the soft tissues (mucosa) in a similar way. The frustoconical shape of the seating increases the surface area of the peripheral wall of the seating against which the screwhead may come to bear. This is particularly advantageous bearing in mind the internal radial housing that reduces the surface area of the peripheral wall of the seating a little. This then yields better distribution of the forces between the screwhead and the transmucosal base, and therefore better fixing of the transmucosal base on the dental implant.

Preferably, provision can be made such that:
the distal portion comprises an axial extension extending axially away from the seating over a length and extending over an angular sector,
the axial extension is situated radially in register with the internal radial housing.

Axially extending the distal portion offers an increased surface area for engagement between the transmucosal base and the dental prosthesis for better fixing of the assembly. The arrangement of the axial extension (preferably only) radially in register with the internal radial housing makes it possible to increase the inclination of the screw away from the longitudinal direction when the free end of its threaded shank engages in the internal radial housing.

Advantageously, the proximal portion may comprise an axial part of non-circular exterior cross section. The dental prosthesis can thus be indexed in terms of rotation (about the longitudinal direction) relative to the transmucosal base to ensure that the internal radial housing and the second passage portion are arranged diametrically opposite (as this further facilitates the introduction of the screw). To do this, the first passage portion of the dental prosthesis may preferably comprise an axial part of non-circular interior cross section able to collaborate with the axial part of non-circular exterior cross section of the proximal portion of the transmucosal base so as to index the dental prosthesis in terms of rotation relative to the transmucosal base.

As a preference, the distal portion may comprise an axial part of non-circular exterior cross section.

The transmucosal base can thus be reliably indexed in terms of rotation (about the longitudinal direction) relative to the dental implant and as a result the dental prosthesis can thus be reliably indexed in terms of rotation relative to the dental implant when there is also rotational indexing between the transmucosal base and the dental prosthesis.

According to another aspect, the present invention proposes an assembly comprising:
a transmucosal base as described hereinabove,
a screw.

Advantageously, the assembly may further comprise a dental prosthesis intended to be mounted and fixed, or pre-mounted and pre-fixed, on the distal portion of the transmucosal base, said dental prosthesis comprising a through-passage substantially formed by first and second successive passage portions, said first passage portion extending from a proximal end of the dental prosthesis substantially along a first longitudinal axis and said second passage portion extending the first passage portion substantially along a second longitudinal axis such that the first and second passage portions make between them a non-zero angle.

As a preference, for simplicity and the sake of compactness, the dental prosthesis may be fixed on the transmucosal base by adhesive bonding.

Advantageously, the first passage portion may comprise an axial part of non-circular interior cross section, able to collaborate with the axial part of non-circular exterior cross section of the distal portion of the transmucosal base so as to index the dental prosthesis in terms of rotation relative to the transmucosal base.

According to another aspect, the present invention proposes a method for manufacturing an assembly intended to be received in or on a dental implant, comprising the following steps:
a) supplying a transmucosal base as described hereinabove,
b) supplying a dental prosthesis comprising a through-passage substantially formed by first and second successive passage portions, said first passage portion extending from a proximal end of the dental prosthesis substantially along a first longitudinal axis and said second passage portion extending the first passage portion substantially along a second longitudinal axis such that the first and second passage portions make between them a non-zero angle,
c) mounting and fixing the dental prosthesis on the distal portion of the transmucosal base.

In a simple way, during step c), the dental prosthesis may be fixed on the transmucosal base by adhesive bonding.

### BRIEF DESCRIPTION OF THE DRAWINGS

Further objects, features and advantages of the present invention will become apparent from the following description of some particular embodiments, which is given with reference to the attached figures, among which:

FIG. 1 is a perspective view of a transmucosal base according to one particular embodiment of the present invention;

FIG. 2 is a side view of the transmucosal base of FIG. 1;

FIG. 3 is another perspective view of the transmucosal base of FIG. 1;

FIG. 4 is a perspective view of a dental prosthesis intended to be received on the transmucosal base of FIG. 1;

FIG. 5 is a side view in partial section of an assembly comprising the transmucosal base of FIG. 1, the dental prosthesis of FIG. 4, and a fixing screw;

FIG. 6 is a perspective view of the assembly of FIG. 5 with a dental implant;

FIG. 7 is a view in section of the assembly of FIG. 5 positioned on a dental implant during introduction of the fixing screw; and

FIG. 8 is a view in section of the assembly of FIG. 5 positioned on a dental implant after the fixing screw has been screwed into the dental implant.

### DESCRIPTION OF THE PREFERRED EMBODIMENTS

When identical numerical references are used in a number of figures, variants or embodiments of the invention, these numerical references denote elements that are identical or similar in each of the figures, each of the variants or each of the embodiments.

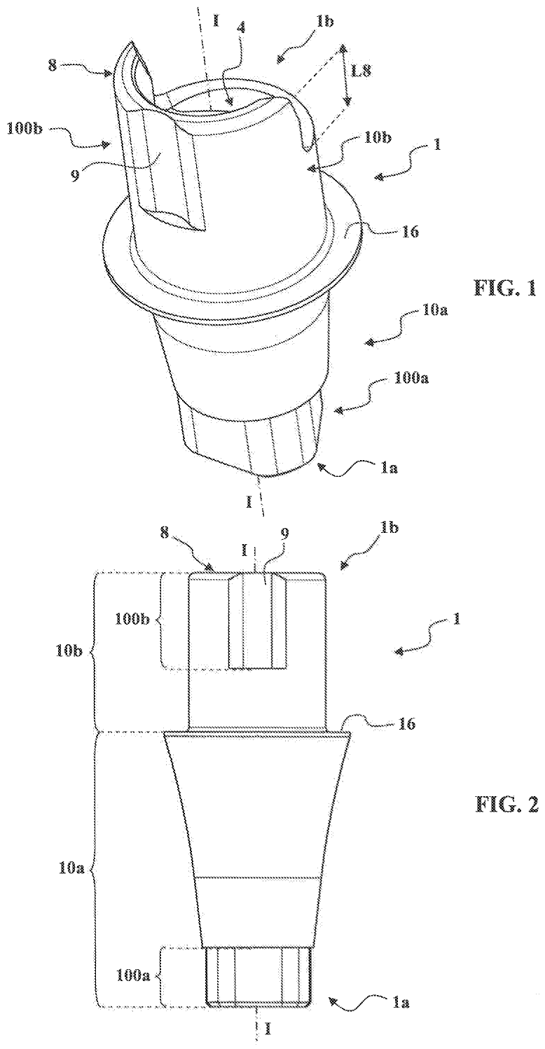

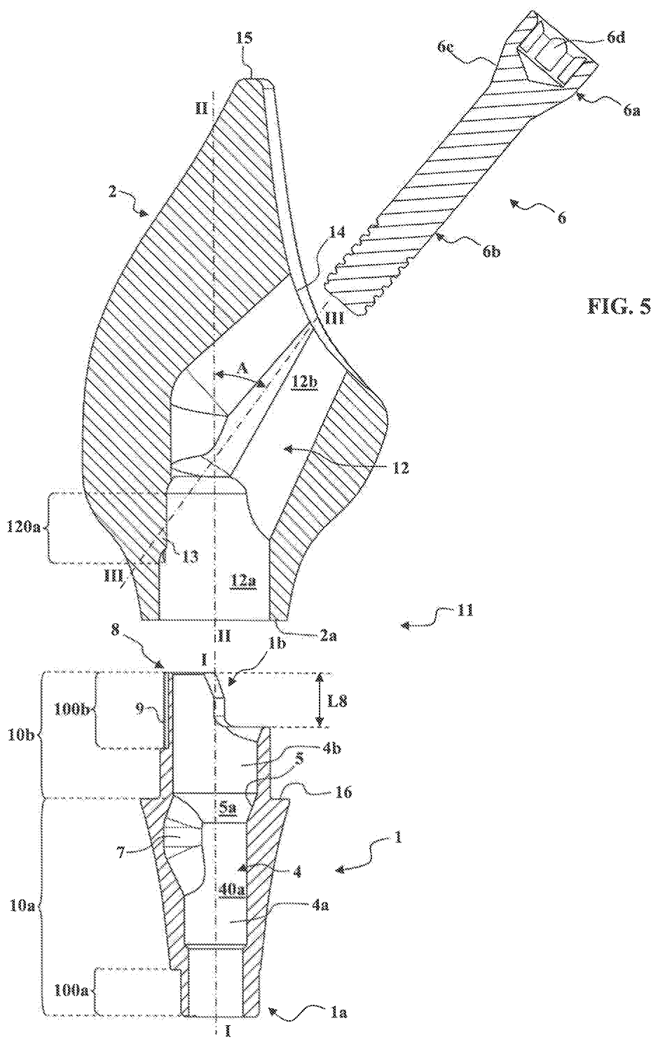

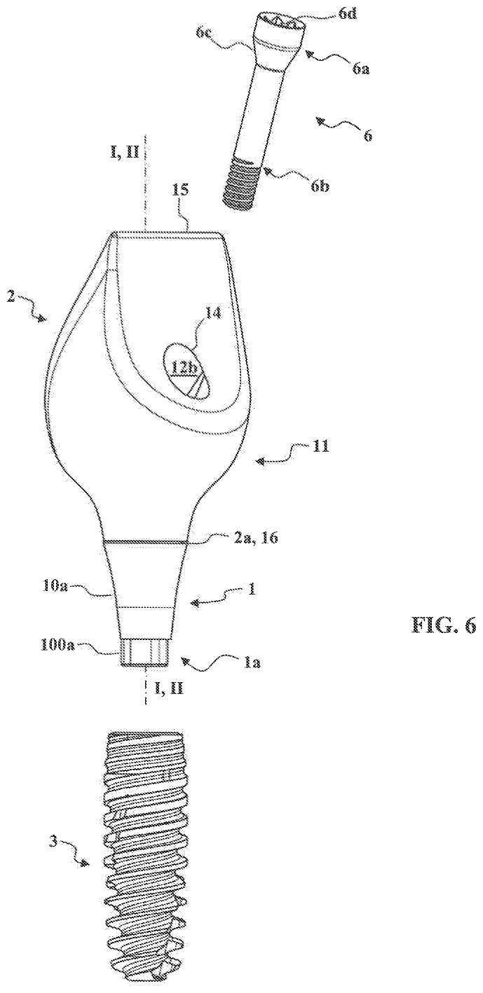

FIG. 1 illustrates one particular embodiment of a transmucosal base 1 according to the present invention, for receiving a dental prosthesis 2 (FIGS. 4 to 8) on a dental implant 3 (FIGS. 6 to 8).

The transmucosal base 1 (FIGS. 1 to 3 and 5 in particular) extends in a longitudinal direction I-I between a proximal end 1a and a distal end 1b and comprises:
a proximal portion 10a shaped to be received in or on a dental implant 3,
a distal portion 10b shaped to support the dental prosthesis 2,
a longitudinal through-passage 4 successively comprising an upstream cylindrical portion 4b extending in the direction of the proximal end 1a as far as a seating 5 bounded by a seating peripheral wall 5a and having a bearing surface intended to have the head 6a of a screw 6 (FIGS. 5 to 8) bearing axially against it, and a downstream cylindrical portion 4a bounded by a lateral wall 40a and extending from and away from the seating 5 in the direction of the proximal end 1a.

The transmucosal base 1 comprises, in the longitudinal through-passage 4, an internal radial housing 7 formed in the peripheral wall 5a of the seating 5 and in the lateral wall 40a of the downstream cylindrical portion 4a.

The distal portion 10b comprises an annular bearing surface 16 intended to have the proximal end 2a of the dental prosthesis 2 bearing axially against it.

FIG. 5 more particularly shows that
the proximal portion 10a flares progressively in the direction of the distal portion 10b,
the seating 5 is frustoconical, flaring in the direction of the upstream cylindrical portion 4b, the internal radial housing 7 being partially formed in the peripheral wall 5a of the seating 5.

The head 6a of the screw 6 comprises a frustoconical portion 6c complementary to the seating 5 so that the screw 6 bears uniformly against the peripheral wall of the seating 5a.

FIGS. 1, 3 and 5 more particularly show that the distal portion 10b comprises an axial extension 8 extending axially away from the seating 5 over a length L8 and extending over an angular sector (here of approximately 180 degrees). The axial extension 8 is substantially in the form of a semi-tubular wall in the form of an arc of a circle.

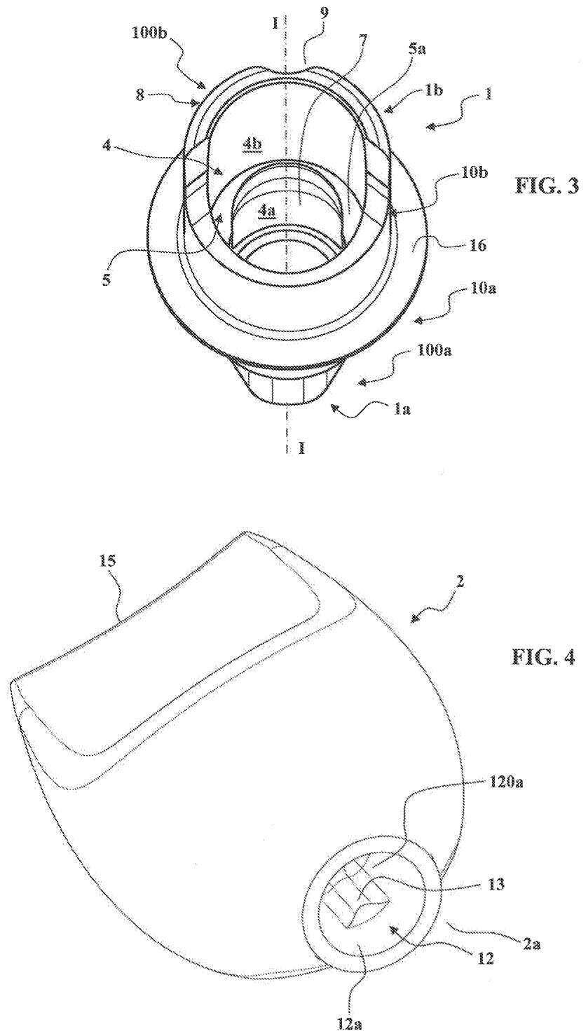

The axial extension 8 is situated radially in register with the internal radial housing 7 (FIGS. 3 and 5). In other words, the axial extension 8 is situated plumb, in the longitudinal direction I-I, with the internal radial housing 7.

It is more particularly visible in FIGS. 1 to 3 that the proximal portion 10a comprises an axial part 100a of non-circular exterior cross section. More specifically, the axial part 100a here has an exterior cross section that is substantially triangular with rounded vertices. This non-circular exterior cross section is intended to collaborate with a substantially complementary axial part 30a of a female housing 3a of the dental implant 3 so as to index the transmucosal base 1 in terms of rotation relative to the dental implant 3 (about the longitudinal direction I-I).

It is more particularly visible in FIGS. 1 to 3 and 5 that the distal portion 10b comprises an axial part 100b of non-circular exterior cross section. This non-circular exterior cross section here is afforded by an axial slot 9 formed on the outside of the axial extension 8.

The seating 5 comprises a bearing surface that represents at least 50% of the surface that the seating 5 would have had in the absence of the internal radial housing 7. In FIG. 3 it may be seen that the seating 5 has a bearing surface that is even greater than 50% of the surface that the seating 5 would have had in the absence of the internal radial housing 7.

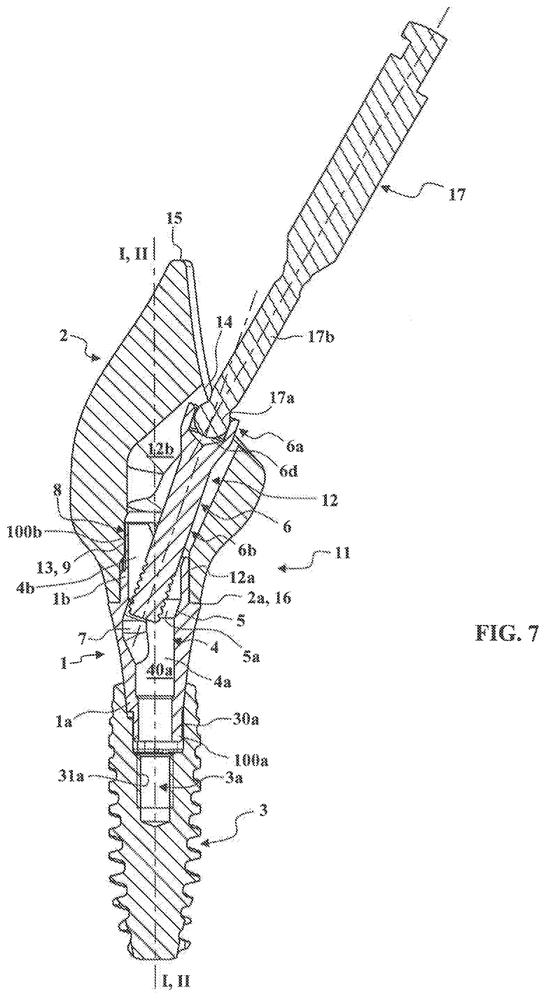

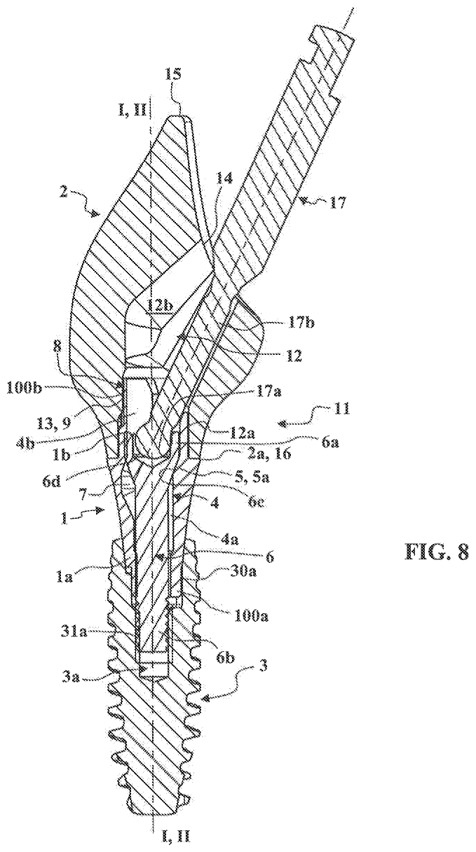

FIG. 5 depicts an assembly 11 comprising:
a transmucosal base 1,
a screw 6 comprising a screwhead 6a and a threaded shank 6b intended to be screwed into the dental implant 3 (into a threaded axial part 31a of the female housing 3a of the implant 3, see FIGS. 7 and 8) in order to fix the transmucosal base 1 on said dental implant 3.

The assembly 11 further comprises a dental prosthesis 2 intended to be mounted and fixed, or pre-mounted and pre-fixed, on the distal portion 10b of the transmucosal base 1.

Said dental prosthesis 2 comprises a through-passage 12 substantially formed by first 12a and second 12b successive passage portions, said first passage portion 12a extending from a proximal end 2a of the dental prosthesis 2 substantially along a first longitudinal axis II-II and said second passage portion 12b extending the first passage portion 12a substantially along a second longitudinal axis III-III such that the first 12a and second 12b passage portions make between them a non-zero angle A.

The angle A makes it possible for example for the orifice 14 of the second passage portion 12b to be situated well away from the free edge 15 of the dental prosthesis 2.

The dental prosthesis 2 is intended to be fixed on the transmucosal base 1, preferably by adhesive bonding.

It may be seen more particularly from FIGS. 4 and 5 that the first passage portion 12a comprises an axial part 120a of non-circular interior cross section. This non-circular interior cross section is more specifically afforded by an axial rib 13.

The non-circular interior cross section of the axial part 120a is more particularly able to collaborate with the non-circular exterior cross section of the axial part 100b of the distal portion 10b of the transmucosal base 1 to index the dental prosthesis 2 in terms of rotation relative to the transmucosal base 1.

For this purpose, when the dental prosthesis 2 is received on the transmucosal base 1 by push-fitting (and adhesive bonding) of the distal portion 10b into the first passage portion 12a, the axial rib 13 engages axially in the axial slot 9.

The use of the transmucosal base 1 by a dental practitioner will now be explained in greater detail by means of FIGS. 5 to 8.

The first step is to provide a transmucosal base 1 according to the invention and as described hereinabove, of which the length (in the longitudinal direction I-I) of the proximal portion 10a is suited to the gum height of the patient. In practice, the proximal portion 10a needs to be substantially flush with the upper level of the gum tissues.

A dental prosthesis 2 as described hereinabove, having a through-passage 12, is also supplied. The dental prosthesis 2 may for example be manufactured by machining from a block of ceramic.

The operator begins by mounting and fixing the dental prosthesis 2 on the transmucosal base 1, preferably using adhesive bonding.

What is thus employed is a method for manufacturing an assembly 11 intended to be received in or on a dental implant 3, comprising the following steps:
a) supplying a transmucosal base 1 according to the invention,
b) supplying a dental prosthesis 2 comprising a through-passage 12 substantially formed by first 12a and second 12b successive passage portions, said first passage portion 12a extending from a proximal end 2a of the dental prosthesis 2 substantially along a first longitudinal axis II-II and said second passage portion 12b extending the first passage portion 12a substantially along a second longitudinal axis III-III such that the first 12a and second 12b passage portions make between them a non-zero angle A,
c) mounting and fixing the dental prosthesis 2 on the distal portion 10b of the transmucosal base 1, preferably using adhesive bonding.

Upon assembly of the dental prosthesis 2 on the transmucosal base 1, the proximal end 2a of the dental prosthesis 2 comes to bear axially on the distal portion 10b of the transmucosal base 1 (more particularly on the annular bearing surface 16) and the axial slot 9 and rib 13 collaborate with one another to immobilize the dental prosthesis 2 and the transmucosal base 1 relative to one another in terms of rotation in the longitudinal direction I-I. The distal portion 10b is push-fitted into the first passage portion 12a to effectively take up rocking stresses.

This then yields the assembly 11 as illustrated in FIG. 6.

What is also supplied is a screw 6 with a screwhead 6a and threaded shank 6b of a length suited to engaging by screw-fastening in the threaded axial part 31a of the female housing 3a of the dental implant 3 (which is situated in the mouth of the patient).

The practitioner mounts the assembly 11 in the dental implant 3 by engaging the axial part 100a in the female interior housing 3a of the dental implant 3 in order to immobilize the assembly 11 relative to the dental implant 3 about the longitudinal direction I-I.

The practitioner can then insert the screw 6 into the through-passage 12 by the orifice 14, engaging the screw 6 in an oblique direction relative to the longitudinal direction I-I (which coincides with the first longitudinal axis II-II).

The free end of the threaded shank 6b enters the internal radial housing 7 to allow the screwhead 6a to enter the through-passage 12 and allow the screw 6 then to be straightened up in the longitudinal direction I-I.

Once it has been straightened in the longitudinal direction I-I, the screw 6 can be turned by a screw-driving tool 17 having a shank 17b and a faceted screw-tightening head 17a, which tool is engaged in the through-passage 12. The threaded shank 6b is thus screwed into the threaded axial part 31a.

The screw-driving tool 17 here is similar to the one described in document EP 2 607 722 A1, and the faceted screw-tightening head 17a engages in a six-sided socket 6d in the screwhead 6a. The head 17a of the screw-driving tool 17 allows the shank 17b of the screw-driving tool 17 to sit at an angle with respect to the threaded screw shank 6b during the tightening or loosening of the screw (FIG. 8).

At the end of screwing, the configuration is that illustrated in FIG. 8: the screwhead 6a is bearing against the seating 5 and presses the transmucosal base 1 against the dental implant 3.

The practitioner can then withdraw the screw-driving tool 17 and replug the orifice 14 which is oriented toward the inside of the patient's mouth. The orifice 14 is thus hidden from sight by other people when the patient smiles, affording a satisfactory esthetic.

The orifice 14 is formed away from the free edge 15 of the dental prosthesis 2, which thus benefits from a thickness of material that is great enough to withstand the stresses of chewing and also so that it can exhibit a coloration that is unaffected by a transparency effect.

In the absence of the internal radial housing 7, the angle A would have been smaller and the orifice 14 would have had to be positioned closer to the free edge 15 in order to allow the screw 6 to be inserted.

If a maintenance operation needs to be performed on the dental prosthesis 2, there is no need to separate the dental prosthesis 2 from the transmucosal base 1: once the orifice 14 has been reopened, the screw-driving tool 17 can be inserted (as illustrated in FIG. 8) until it engages in the screwhead 6a, then the screw 6 can be turned in order to extract it from the threaded housing of the dental implant 3.

Following unscrewing, the assembly 11 (which comes out in one piece) can be removed from the patient's mouth in order to perform maintenance, and the screw 6 can also be extracted from the assembly 11.

The present invention is not restricted to the embodiments which have been explicitly described but rather includes the diverse variants and generalizations that are encompassed within the scope of the claims that follow.

1-12. (canceled)

13. A transmucosal base for receiving a dental prosthesis on a dental implant, extending in a longitudinal direction (I-I) between a proximal end and a distal end, comprising:
a proximal portion shaped to be received in or on a dental implant,
a distal portion shaped to support a dental prosthesis,
a longitudinal through-passage successively comprising an upstream cylindrical portion extending in the direction of the proximal end as far as a seating bounded by a seating peripheral wall and having a bearing surface intended to have the head of a screw bearing axially against it, and a downstream cylindrical portion bounded by a lateral wall and extending from and away from the seating in the direction of the proximal end,
wherein the transmucosal base comprises, in the longitudinal through-passage, an internal radial housing formed in the peripheral wall of the seating and in the lateral wall of the downstream cylindrical portion.

14. The transmucosal base as claimed in claim 13, wherein:
the proximal portion is progressively flared in the direction of the distal portion,
the seating is frustoconical, flaring in the direction of the upstream cylindrical portion, the internal radial housing being formed in part in the peripheral wall of the seating.

15. The transmucosal base as claimed in claim 13, wherein:
the distal portion comprises an axial extension extending axially away from the seating over a length (L8) and extending over an angular sector,
the axial extension is situated radially in register with the internal radial housing.

16. The transmucosal base as claimed in claim 13, wherein the proximal portion comprises an axial part of non-circular exterior cross section.

17. The transmucosal base as claimed in claim 13, wherein the distal portion comprises an axial part of non-circular exterior cross section.

18. The transmucosal base as claimed in claim 13, wherein the seating has a bearing surface which represents at least 50% of the surface that the seating would have had in the absence of the internal radial housing.

19. An assembly comprising:
a transmucosal base as claimed in claim 13, and
a screw.

20. The assembly as claimed in claim 19, further comprising a dental prosthesis intended to be mounted and fixed, or pre-mounted and pre-fixed, on the distal portion of the transmucosal base, said dental prosthesis comprising a through-passage substantially formed by first and second successive passage portions, said first passage portion extending from a proximal end of the dental prosthesis substantially along a first longitudinal axis (II-II) and said second passage portion extending the first passage portion substantially along a second longitudinal axis (III-III) such that the first and second passage portions make between them a non-zero angle (A).

21. The assembly as claimed in claim 20, wherein the dental prosthesis is fixed on the transmucosal base by adhesive bonding.

22. The assembly as claimed in claim 20, wherein the first passage portion comprises an axial part of non-circular interior cross section, able to collaborate with the axial part of non-circular exterior cross section of the distal portion of the transmucosal base so as to index the dental prosthesis in terms of rotation relative to the transmucosal base.

23. A method for manufacturing an assembly intended to be received in or on a dental implant, comprising the following steps:
a) supplying a transmucosal base as claimed in claim 13,
b) supplying a dental prosthesis comprising a through-passage substantially formed by first and second successive passage portions, said first passage portion extending from a proximal end of the dental prosthesis substantially along a first longitudinal axis (II-II) and said second passage portion extending the first passage portion substantially along a second longitudinal axis (III-III) such that the first and second passage portions make between them a non-zero angle (A), and
c) mounting and fixing the dental prosthesis on the distal portion of the transmucosal base.

24. The method as claimed in claim 23, wherein, during step c), the dental prosthesis is fixed on the transmucosal base by adhesive bonding.
